(19) United States
(12) Patent Application Publication
(10) Pub. No.: US 2004/0135389 A1
(43) Pub. Date: Jul. 15, 2004

(54) Lifting device for manhole tops and manhole covers

(76) Inventor: Robert J. Helms, Edwardsville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/339,113

(22) Filed: Jan. 9, 2003

(51) Int. Cl. B66C 1/42

(52) U.S. Cl. 294/110.1; 294/118

(57) ABSTRACT

A lifting device for lifting manhole tops and manhole covers. The lifting device includes a scissor arrangement consisting of two crossed arms. Each arm includes a gripping assembly for grasping a manhole top and a set of hooks for lifting a manhole cover. One of the arms is offset to provide greater gripping ability for the lifting device and to provide a more compact lifting device. Chains are connected to ends of each arm to allow raising of the lifting device. Raising the lifting device by the chains causes the gripping assemblies to come together horizontally and grip the perimeter of the manhole top or, in the case of the manhole cover, the arms come together to set the hooks into slots on the manhole cover. The weight of the object lifted creates a horizontal gripping force to urge the gripping assemblies into lifting contact with the object.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates in general to a lifting device and, more particularly, to a lifting device for use in lifting manhole tops and manhole covers.

2. Description of Related Art

In residential and commercial construction, the installation and repair of storm sewer lines and sanitary sewers lines is a common occurrence. The design of all types of sewer line mandates the placement of a manhole at every point where there is a change in direction of the sewer line. Thus, at the apex point of every angle made within a sewer line, a manhole can be found.

Each of these manholes normally consists of a circular tower-like construction of concrete, bricks, and mortar topped off by a heavy metal manhole top. To allow access into the manhole tower and the sewer line below, the manhole top has a manhole cover. Because the manhole cover is usually located at ground or street level, the manhole cover is generally made from very heavy metal to prevent the displacement or breakage of the manhole cover which would otherwise allow an unsuspecting person walking upon the cover to fall into the manhole and sustain serious injury.

Due to these design consideration, the manhole top and the manhole cover are very heavy. Additionally, the manhole top and the manhole cover are virtually always circular in shape. The combination of the heavy weight and the awkward shape of the manhole tops and manhole covers make it very difficult to move and place these items onto the manhole towers during installation and off of the manhole towers during repair.

This is particularly true because the bottom of the manhole cover and the manhole top must be kept clear of lifting hooks and other such items during installation. Because the manhole top must lay flat upon the top of the manhole tower, any lifting hook which holds the manhole top from underside would interfere with the placement of the manhole top. Due to the circular shape and design of the manhole top, there are no other points where other types of lifting devices can be attached to the manhole top for lifting and moving the top.

A similar situation arises with the manhole cover. Although most manhole covers have two slots located about 180 degrees part on the upper surface of the manhole cover, these slots are more readily used for insertion of a pry bar into the tops to disengage the manhole cover from the manhole top than for lifting and placing the manhole cover onto the manhole top. Because the perimeter of the manhole cover has very little clearance when installed within the circular opening of the manhole top, it can be very problematic to place the manhole cover into the manhole top without snagging the lifting device being used between the manhole cover and the manhole top.

Previous attempts to create a lifting device to lift manhole covers have suffered from various disadvantages. In U.S. Pat. No. 6,276,732 issued to Hauss, a lifting device is disclosed which may be used to lift and place manhole covers. The lifting device disclosed is primarily for hand use wherein two person manually lift a scissor-like arrangement of lengthy arms. Plate members at the end of the two arms contact the upper ring of a manhole when the two people lift upward on the device. While this device may lift manholes tops, there is no provision to lift manhole covers. Additionally, the straight line arrangement of the arms makes the lifting device large and cumbersome as well as acting to reduce the amount of horizontal grip the plate members have on the manhole top. While there are eyehole members on the device for allowing a lifting cable to be used to connect the device to a manhole top for relocation, the relatively central location of these eyehole members acts to further reduce the leverage of the handles and this results in even lower horizontal forces at the plate members gripping the manhole top. Altogether, the oversize style of the device and the lower horizontal grip from the device act to reduce the capability of the device.

U.S. Pat. No. 4,572,566 issued to Terrington also discloses a lifting device having scissor-like action. However, the overall design is almost identical to the Hauss device above. The arms of the scissors are straight and long. Additionally, the device is made for lifting slabs and would be unable to lift a manhole top or manhole cover. Even more importantly, the straight line scissor arms fail to provide the greatest horizontal grip available. While the device also has a central washer hole which would allow a cable to be attached to the device for lifting the device and an object, as in the Hauss device, the central location of the central washer hole acts to reduce the amount of horizontal gripping force at the gripping areas at the ends of the scissor arms.

In U.S. Pat. No. 6,286,881 issued to Yakushinji, a load clamping and lifting device is disclosed. While the device generally incorporates a scissor action, this device has folded back the scissor arms in a manner which allows the top ends of the arms to meet at the center for connection to a lifting cable. While this device may be capable of lifting objects, a great deal of mechanical leverage is lost when there is a large vertical dimension between the gripping points and the lifting point.

In addition to the lifting problems in each of the above devices, none of these devices is capable of lifting both manhole tops and manhole covers.

Thus, despite the existence of these various types of lifting devices, there is no lifting device which provides a compact scissor-like design which gives a high level of horizontal force for gripping manhole tops and manhole covers.

### SUMMARY OF THE INVENTION

The present invention overcomes these and other problems by providing a lifting device having the ability to lift manhole tops and manhole covers, and which provides enhanced horizontal gripping abilities. Specifically, the present invention resides in a lifting device which incorporates a compact scissor mechanism having an offset scissor arm which reduces the overall size of the lifting device while at the same time enhancing the gripping ability of invention. Additionally, the present invention provides a single device which can be used to grip both manhole tops and manhole covers without the need for adding or removing auxiliary attachments.

The present invention also resides in the various embodiments of the above invention. Other objects and features of the present invention will be in part apparent and in part pointed out hereinafter.

### DESCRIPTION OF THE DRAWINGS

FIG. 1 is a front view of the lifting device in relation to a standard manhole cover and manhole top.

FIG. 2 is a side view of the lifting device showing the operation of the lifting device when used to lift a manhole cover.

FIG. 3 is a side view of the lifting device showing the operation of the lifting device when used to lift a manhole top.

FIG. 4 is a side view of the gripping assemblies.

FIG. 5 is a cross section of the gripping assemblies.

FIG. 6 is a side view of the manhole cover hooks.

Corresponding reference characters indicate corresponding parts throughout the several views of the drawings.

### DETAILED DESCRIPTION OF THE INVENTION

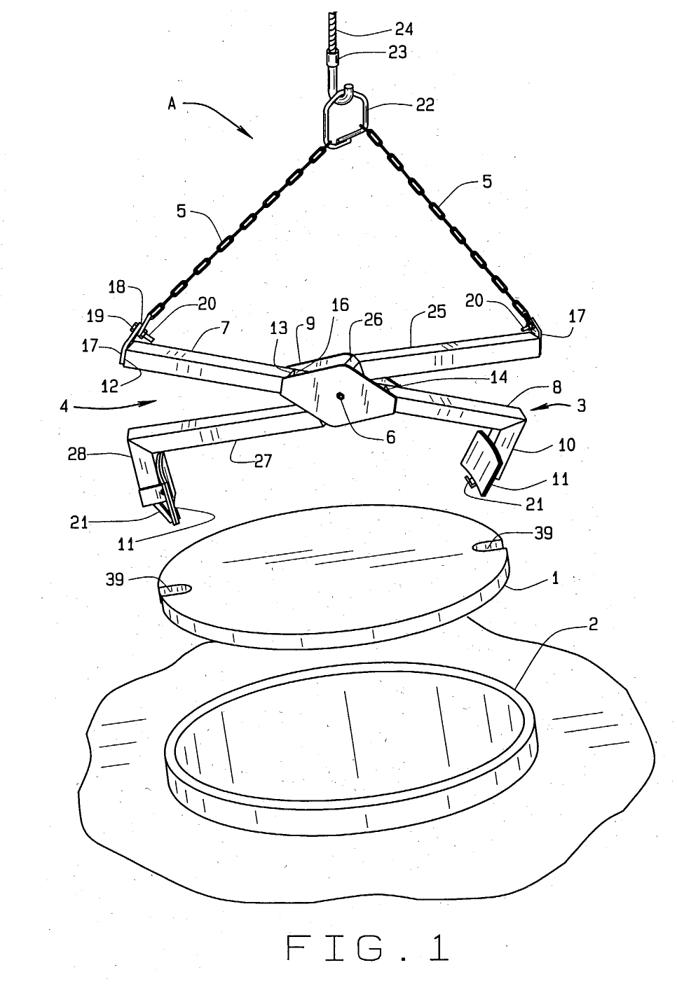

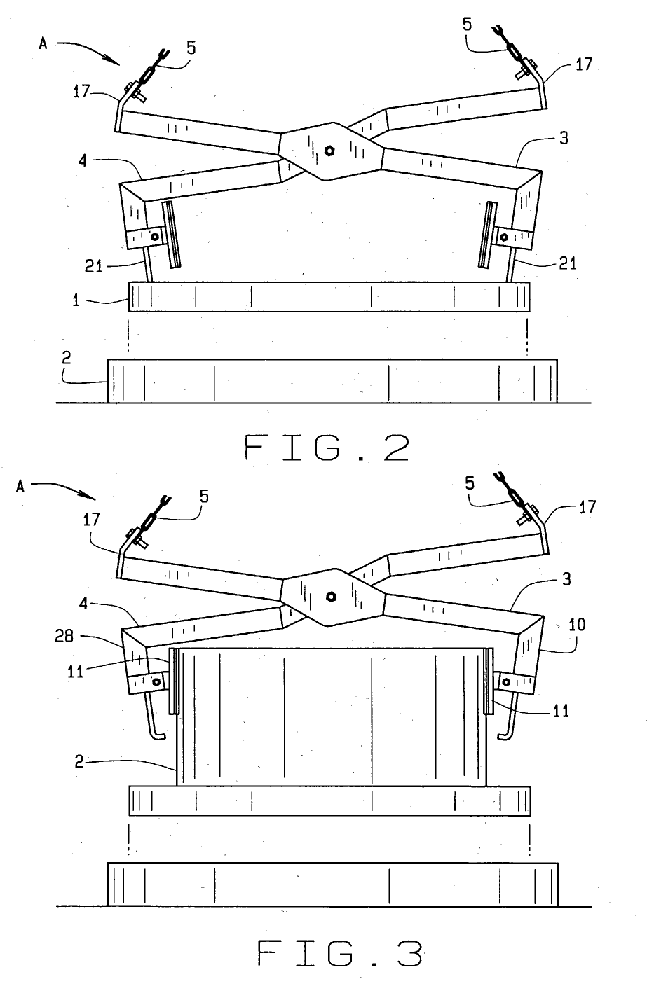

Referring now to the drawings, FIG. 1 shows one embodiment of the present invention. A lifting device A is used to lift either a manhole cover 1 or a manhole top 2, or a manhole top 2 in combination with the manhole cover 1 wherein the manhole cover 1 is placed within and upon the manhole top 2. The lifting device A consists of a first scissor arm 3 and a second scissor arm 4 which are attached at a pivot point 6. Two lifting chains 5 are attached to one end of the scissor arm 3 and the scissor arm 4.

The first scissor arm 3 includes a first arm segment 7, a second arm segment 8, two connector plates 9, a return segment 10, a gripper assembly 11, and a manhole cover hook 21. The first arm segment 7 has a distal end 12 and a proximal end 13. The second arm segment 8 has a distal end 14 and a proximal end 15. In the embodiment shown in FIG. 1, the first arm segment 7 and the second arm segment 8 are made from a high strength square metal tubing. In other embodiments, any other structural material may be used so long as the material is strong enough to support the loads the lifting device is anticipated to carry.

The first arm segment 7 and the second arm segment 8 are connected together by the two connector plates 9 such that there is a gap 16 between the proximal end 13 of the first arm segment 7 and the distal end 14 of the second arm segment 8. In the embodiment shown, the connector plates 9 are substantially diamond-shaped.

The two connector plates 9 hold the first segment 7 and the second segment 8 in alignment and are attached to the first and second segments by welding the two connector plates to the segments. While in the preferred embodiment the two connector plates 9 are welded to the first segment 7 and the second segment 8, other means may be used, such as fasteners or other similar devices, provided the means selected must be capable of firmly attaching the two connector plates 9 to the segments 7 and 8 and be able to withstand the forces exerted on the scissor arm 3 without deformation of any scissor arm components or other structural failure. Each connector plate 9 has a round opening 16 and the round opening of one connector plate 9 is in axial alignment with the round opening of the other connector plate 9 after the two connector plates have been connected to the first arm segment 7 and the second arm segment 8.

The return segment 10 is substantially perpendicular to the second arm segment 8. In the embodiment shown, the return segment 10 is a separate piece of square tubing which has been mitered and welded to the proximal end 15 of the second arm segment 8. In other embodiments, the return segment can be formed as an integral portion of the second arm segment 8 by bending one end portion of the segment 8 until the end portion is perpendicular to the main body of the second arm segment 8.

A chain connector plate 17 is attached to the distal end 12 of the first arm segment 7. The chain connector plate 17 is shaped to match the generally square form of the distal end 12 of the first arm segment 7. The chain connector plate 17 also has a bent end 18 which has a mounting hole 19. The end of one chain 5 is connected to the chain connector plate 17 by installing a fastener 20 through the mounting hole 19 and through the opening in the end link of the chain 5. In the preferred embodiment, the fastener 20 includes a high strength bolt, a high strength nut, a washer directly under the head of the high strength bolt, and another washer between the high strength nut and the chain 5.

It will be appreciated that there a number of ways in which the chains 5 can be attached to the first scissor arm 3 or second scissor arm 4. For example, in lieu of a chain connector plate 17, the chains could be directly connected to the end of the scissor arm 3 or 4 with fasteners such as eye bolts, chain repair links, or other general fasteners. Any type of chain connection method may be used as long as the scissor arms 3 and 4 are allowed to produce the scissor action described herein and the fastening method used is strong enough to sustain the forces placed on the chain connection point during use of the lifting device A.

The second scissor arm 4 has a first arm segment 25, an offset arm segment 26, a second arm segment 27, a return segment 28, a gripper assembly 11, and a manhole cover hook 21. Similar to the first scissor arm 3, the scissor arm 4 is constructed of a metal tube. In other embodiments, other materials such as solid round bars and solid square bars may also be used.

The shape of the second scissor arm 4 is different than the first scissor arm 3. Rather than having all of the arms segments be aligned, the arm segments of the second scissor arm 4 are offset near the longitudinal center of the scissor arm 4 where the first scissor arm 3 pivots with the second scissor arm 4. More specifically, the offset segment 26 is mitered at each of its ends at an angle that allows the offset segment 26 to be connected with matching miters on the ends of the first arm segment 27 and the second arm segment 25. The miter angles are such that when the first arm segment 25, the offset segment 26, and the second arm segment 27 are assembled, the fist arm segment 25 and the second arm segment 27 are generally parallel.

As with the return segment 10 of the first scissor arm 3, the return segment 28 of the second scissor arm 4 is substantially perpendicular to the second arm segment 27. In the embodiment shown, the return segment 28 is a separate piece of square tubing which has been mitered and welded to the one end of the second arm segment 27. In other embodiments, the return segment can be formed as an integral portion of the second arm segment 27 which has been bent until the end portion is perpendicular to the main body of the second arm segment 27.

A ring 22 connects together the other ends of the two chains 5 to from a lifting point where a hook 23 can be used to grab the ring 22 for raising the lifting device A. The hook 23 is normally connected to a lifting chain 24. It will be appreciated that the same fastener 20 which is used to connect one end of each chain to the chain connector plate 17 at the end of the first arm segment 7 and the arm segment 25 is also used to connect the two chains 5 to the ring 22.

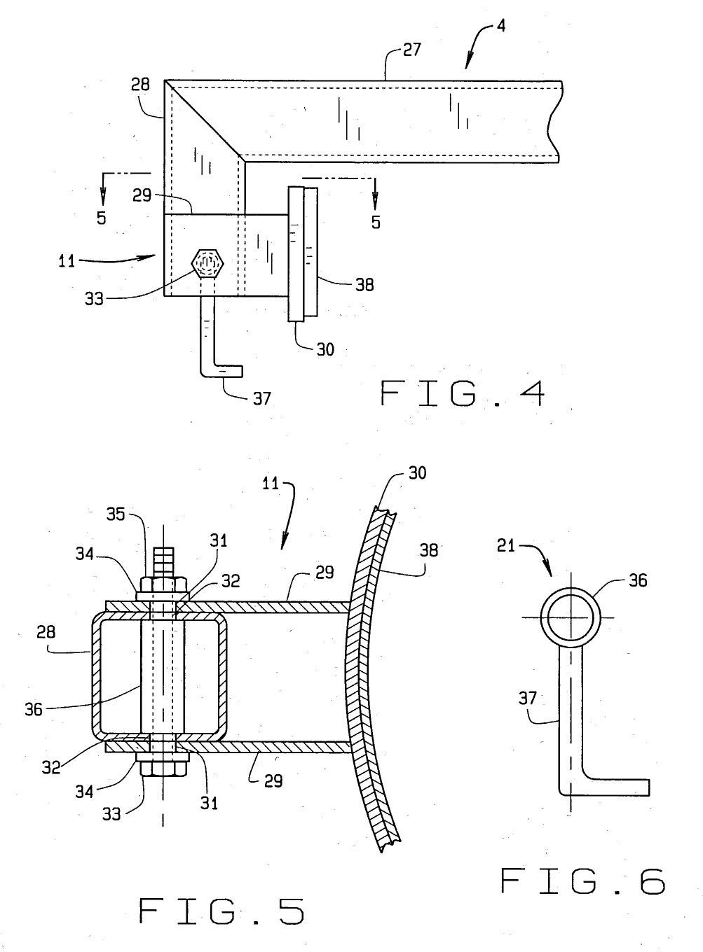

Referring now to FIG. 4, a gripper assembly 11 is attached to one end of each of the scissor arms 3 and 4. The gripper assembly 11 includes two hinge plates 29 attached to plate 30, the two hinge plates 29 being spaced apart to allow the return segment 28 of the scissor arm 3 or 4 to slide between the two hinge plates 29. The two hinge plates 29 are located symmetrically on the back surface of the plate 30. The plate 30 is curved to match the radius of the outside perimeter found on a standard manhole top.

Each hinge plate 29 (FIG. 5) has a round opening 31 which is located on the horizontal centerline of the hinge plates 29 and which is located to be on the longitudinal centerline of the return segment 28. The return segment 28 has two second round opening 32 which are sized to match the two round openings 31 and are located to allow for the axial alignment of both round openings 31 with both round openings 32. In the embodiment shown, a gripping pad 38 made from a resilient material such as rubber is attached to the surface of the plate 30 with a plurality of rivets, although any method of attaching the gripping pad 38 to the plate 30 is suitable as long as the gripping pad is not displaced during use of the lifting device and the method of attachment is generally water resistant. It will be appreciated that other types of gripping pads such as smooth pads, pads with a rough surface, pads with horizontal grooves, pads with numerous pointed shapes, or any other similar pad that is made from any type of material, can be used as long as the design of the gripping pad and the material used provides sufficient friction coefficient between the manhole top 2 and the gripping pads 38 to allow the manhole top 2 to be lifted by the lifting device A without slippage of the manhole 2 top from the gripping pads 38.

The two hinge plates 29 are connected to the return segment 28 by axially aligning the round openings 31 and 32, and then installing a bolt 33, two washers 34, and a nut 35. During installation of the bolt 33, the hinge tubing 36 is aligned with the openings 31 and 32 and the bolt 33 is inserted through the hinge tubing 36. Upon proper installation of these components, the hinge tubing 36 will be able to rotate around the outer surface of the bolt 33 with the bolt 33 acting as a hinge pin.

The manhole cover hook 21 (FIG. 6) comprises a hook 37 which is connected to the outer surface of the hinge tube 36. After the manhole cover hook is installed within the return segment 28 (FIG. 5) with the bolt 33, the manhole cover hook can be rotated to allow the manhole cover hook 21 to engage with the lifting slots 39 (FIG. 1) normally found on the manhole cover 1.

While the above description describes the gripper assembly 11 and manhole cover hook 21 on the second scissor arm 4, the gripper assembly 11 and the manhole cover hook 21 of the first scissor arm 3 is the same.

Returning now to FIG. 1, the lifting device A is used to move manhole tops 2 by attaching the lifting device A to a lifting line 24 by attaching the hook 23 onto the chain bridge 22. The lifting device A is raised by the lifting line 24 and moved until the lifting device is positioned over the manhole top 2 to be relocated. The lifting device A (FIG. 3) is lowered over the manhole top 2 until the lifting device A rests upon the manhole top 2 with the gripping assemblies 11 positioned adjacent to the vertical sides of the outside perimeter of the manhole top 2. The two gripping assemblies 11 are swiveled on the return segments 28 and 10 until the surface of the gripping pads 38 is generally parallel with the vertical surface of the outside perimeter of the manhole top 2.

To lift the manhole top 2, the lifting line 24 (FIG. 1) raises the lifting device A. As the lifting device A is raised, the first scissor arm 3 and the second scissor arm 4 pivot at the pivot point 16. As the scissor arms 3 and 4 pivot, the two gripper assemblies 11 move horizontally and in an opposing direction until the gripping pads 38 come into contact with the vertical surface of the outside perimeter of the manhole cover 2. By continuing to raise the lifting device A with the lifting line 24, pressure is increasingly applied to the pads 38 of the gripper assemblies 11 thus allowing the gripping pads 38 to grip the manhole top 2. It should be noted that the gripping force on the gripping pads 38 will be proportionate to the weight of the manhole top 2 being lifted. Additionally, the offset design of the second scissor arm 4 acts to enhance the amount of gripping force to make the lifting device A more efficient than other lifting device designs.

At some point, the raising action of the lifting line 24 will overcome the weight of the manhole top 2 and the gripping force of the gripping assemblies will grip the manhole top 2 to allow the manhole top 2 to be lifted from its resting position. The lifting line 24 is subsequently moved to another position where the lifting line 24 is then lowered to allow the lifting device A and the manhole top 2 to be lowered to its new position As the manhole top 2 comes to rest in its new position, the scissor action of the scissor arms 3 and 4 allows the scissor arms to pivot around pivot point 16, thereby reducing the amount of horizontal gripping force transferred to the gripping pads 38. As the lifting line 24 continues to be lowered, the gripping force on the gripping pads 38 will continue to be reduced until the gripping pads 38 and gripping assemblies 11 can no longer hold the manhole top 2. When this point is reached, the lifting device A will release the manhole top 2 and the relocation of the manhole top 2 is completed.

The process of lifting the manhole cover 1 is similar to the lifting of the manhole top 2 as just described. The lifting device A is moved into position over the manhole cover 1 and then lowered to a point just above the manhole cover. Then, rather than using the gripping assemblies 11 to lift and move the manhole cover 1, the manhole cover hooks 21 are used. Thus, the lifting device A is not lowered completely onto the manhole cover 1, but is instead positioned over the manhole cover 1 until the hooks 37 of the manhole cover hooks 21 are located near the lifting slots 39 in the manhole covers 1. The ends of the hooks 37 are inserted fully into the lifting slots 39 to engage the hooks 37 into the lifting slots 39. Because the manhole cover hooks 21 can be rotated, the lifting hooks 37 are rotated to engage or disengage the hooks 37 with the lifting slots 39 (FIG. 1). The lifting line 24 is then raised to lift the lifting device A with the manhole cover 1 connected to the hooks 37. It is noted that the scissor action of the two scissor arms 3 and 4 enhances the lifting capability of the lifting device A by exerting opposing horizontal pressure on the hooks 37 which tends to encourage the engagement of the hooks 37 with the lifting slots 39.

Using the lifting line 24, the lifting device A and the manhole cover 1 are moved to a new location where the lifting line 24 lowers the lifting device A and the manhole cover 1 into a new position, usually onto the top of a manhole top 2. As the lifting line 24 is further lowered, the pressure on the lifting hooks is reduced to a point where the hooks 37 can be disengaged from the lifting slots 39 of the manhole cover 1.

While the above description describes various embodiments of the present invention, it will be clear that the present invention may be otherwise easily adapted to fit any configuration where a lifting device may be utilized.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What is claimed is:

1. A lifting device for manhole tops and manhole covers, comprising:
a first scissor arm;
a second scissor arm having an offset segment near the center of the second scissor arm, the second scissor arm being pivotally connected to the first scissor arm at a point which is substantially at a longitudinal center of each of the first scissor arm and the second scissor arm;
at least two gripping assemblies for gripping a manhole top, the at least two gripping assemblies being capable of grasping and lifting a manhole top in response to the lifting of one end of each of the first scissor arm and the second scissor arm; and
at least two manhole cover hooks sized and located to engage with at least two lifting slots on a manhole cover.

2. The lifting device of claim 1 further comprising at least two chains connected to one end of each of the first scissor arm and the second scissor arm, the at least two chains being connected at one end by a ring.

3. The lifting device of claim 2 wherein each of the at least two gripping assemblies includes a gripping pad and a grip mounting assembly pivotally connected to a return segment on each of the first scissor arm and the second scissor arm.

4. The lifting device of claim 3 wherein the first scissor arm includes a first arm segment and a second arm segment, the first arm segment and the second arm segment being connected together by two connector plates such that there is a gap between a proximal end of the first arm segment and a distal end of the second arm segment, the two connector plates being located to hold the first arm segment and the second arm segment in a generally parallel alignment.

5. The lifting device of claim 4 further comprising a return segment on each of the first scissor arm and the second scissor arm wherein one of the at least two gripping assemblies is pivotally attached to the return segment on each of the first scissor arm and the second scissor arm.

6. The lifting device of claim 5 wherein each of the first scissor arm and the second scissor arm has a return segment, and wherein one of the at least two manhole cover hooks is pivotally attached to the one end of the return segment on each of the first scissor arm and the second scissor arm.

7. The lifting device of claim 6 further comprising a chain connector plate attached to one end of each of the first scissor arm and the second scissor arm wherein one end of each of the at least two chains is connected to the chain connector plate attached to the first scissor arm and the second scissor arm.

8. A lifting device for manhole tops and manhole covers, comprising:
a first scissor arm;
a second scissor arm having an offset segment near the longitudinal center of the second scissor arm;
means for pivotally connecting the first scissor arm and the second scissor arm near the longitudinal center of each of the first scissor arm and the second scissor arm thereby producing a scissor-like arrangement;
means for gripping a manhole top, said means for gripping being located near at least one end of each of the first scissor arm and the second scissor arm;
means for attaching one end of the first scissor arm and one end of the second scissor arm into at least one lifting slot of a manhole cover; and
means for raising the lifting device in a manner which creates a horizontal gripping force to assist the lifting device in lifting one of either a manhole top or a manhole cover.

9. The process of using a lifting device to lift manhole tops and manhole covers, comprising the following steps:
providing a first scissor arm;
providing a second scissor arm, the second scissor arm having an offset segment near a longitudinal center of the second scissor arm;
pivotally connecting the first scissor arm to the second scissor arm near a longitudinal center of each of the first scissor arm and the second scissor arm to produce a scissor-like arrangement;
providing at least two gripping assemblies for gripping a manhole top; and
providing at least two manhole cover hooks sized and located to engage with at least two lifting slots on a manhole cover, wherein one of the at least two hooks is attached to one end of each of the first scissor arm and the second scissor arm.

10. The process of claim 9 further comprising the steps of:
positioning the lifting device over the manhole top;
lowering the lifting device until the gripping assemblies are aligned near a grasping point on the manhole top;
raising the lifting device such as to cause the at least two gripping assemblies to grasp the manhole top;
lifting the manhole top by raising the lifting device;
lowering the manhole top by lowering the lifting device; and,
releasing the gripping assemblies from the manhole top by lowering the lifting device.

11. The process of claim 9 further comprising the following steps:
positioning the lifting device over a manhole cover;
lowering the lifting device until the manhole cover hooks align and can become engaged with a set of slots on the manhole cover;
engaging the manhole cover hooks into the set of slots on the manhole cover;
raising the lifting device to cause the at two manhole cover hooks to lift the manhole cover;
lifting the manhole cover by raising the lifting device;
lowering the manhole cove by lowering the lifting device; and,
disengaging the two manhole cover hooks from the set of slots in the manhole cover.
